(19) United States
(12) Patent Application Publication
(10) Pub. No.: US 2026/0359472 A1
(43) Pub. Date: Nov. 12, 2026

(54) UNIFIED GENERATIVE ARTIFICIAL INTELLIGENCE (AI) -BASED CHATBOT PLATFORM

(71) Applicant: CenturyLink Intellectual Property LLC, Denver, CO (US)

(72) Inventors: Muhammed Nafi K.A., Erumad (IN); Abhishek V. BENDRE, Dharwad (IN); Hemmy Hanzas Sebastianappan, Bengaluru (IN)

(73) Assignee: CenturyLink Intellectual Property LLC, Denver, CO (US)

(21) Appl. No.: 19/653,943

(22) Filed: Apr. 21, 2026

Related U.S. Application Data
(60) Provisional application No. 63/802,826, filed on May 9, 2025.

(51) Int. Cl. G06F 21/62; G06F 16/334

(52) U.S. Cl. CPC G06F 21/6227; G06F 16/3347

(57) ABSTRACT

Novel tools and techniques are provided for implementing a unified generative artificial intelligence ("AI") -based chatbot platform. The unified generative AI-based chatbot platform implements a single bot application that leverages context switching, role-based access control ("RBAC"), and an adaptive mechanism for dynamically choosing between cache augmented generation ("CAG") and retrieval augmented generation ("RAG") that can seamlessly connect to diverse backend data sources while ensuring stringent data separation and access control. In some examples, an application programming interface ("API") gateway is provided to manage and route requests to the appropriate data sources, which can simplify integration of new data sources and provide a centralized point for implementing security and monitoring features.

### CROSS-REFERENCE TO RELATED APPLICATIONS

This application claims the benefit of U.S. Provisional Application No. 63/802,826 filed May 9, 2025, entitled "Unified Generative Artificial Intelligence (AI)-Based Chatbot Platform," which is incorporated herein by reference in its entirety. To the extent appropriate, a claim of priority is made to the above disclosed application.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing a unified generative artificial intelligence ("AI") -based chatbot platform, and, more particularly, to methods, systems, and apparatuses for implementing a unified generative AI-based chatbot platform interfacing with a single data pool collecting data from across multiple data sources, the unified generative AI-based chatbot platform operating based on role-based access and/or adaptive cache augmented generation ("CAG")/retrieval augmented generation ("RAG").

### BACKGROUND

In today's digital landscape, organizations (such as large enterprises, large service providers, healthcare organizations, government organizations, educational institutions, research institutions, or the like) often manage multiple different business or customer/client/patient services, products, and/or cases, each with its own dedicated data sources and user bases. Existing data access systems require disparate database access systems for individuals having different roles. Such existing systems are typically only set for one of CAG or RAG -based database access. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing a unified generative AI-based chatbot platform, in accordance with various embodiments.

FIG. 2A depicts an example sequence flow for implementing the unified generative AI-based chatbot platform, in accordance with various embodiments.

FIG. 2B depicts role-based relationships between users and bots that are used for implementing the unified generative AI-based chatbot platform, in accordance with various embodiments.

FIGS. 3A and 3B depict flow diagrams illustrating an example method for implementing a unified generative AI-based chatbot platform, in accordance with various embodiments.

FIGS. 4A-4D depict flow diagrams illustrating another example method for implementing a unified generative AI-based chatbot platform, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

As mentioned above, existing data access systems require disparate database access systems for individuals having different roles. Such existing systems are typically only established for CAG-based database access or RAG-based database access, rather than autonomous and adaptive switching between CAG and RAG by the system.

The present technology provides for methods and systems for implementing a unified generative AI-based chatbot platform interfacing with a single data pool collecting data from across multiple data sources. The unified generative AI-based chatbot platform operates based on role-based access and/or adaptive CAG/RAG. In particular, the system includes a single chatbot interface or a single chatbot platform, where one chatbot acts as a single interface and can work as a different platform by context switching (e.g., by enabling switching between user profiles, user roles, and/or chatbots assigned to particular user roles restricting database access based on user roles, or the like). In this manner, the system acts as a unified platform that can be leveraged by professionals across various business/technical/user groups, eliminating the necessity for distinct platforms for different use cases. The platform allows the chatbot to adapt to different use cases without requiring modifications to the underlying system, and incorporates role-based access control ("RBAC") to ensure that users can only access data for which they have appropriate permissions, while preventing users who do not have privileges or credentials from accessing other data in the database system. An administrator has the right to create roles and bots, and the right to assign them to users. Additionally, the platform employs an adaptive CAG/RAG mechanism that dynamically chooses between CAG and RAG to enhance performance, delivering prompt and contextually relevant responses based on specific criteria. This approach improves the performance and response speed of chatbots by maintaining a context cache, which allows access to and use of relevant historical information during text generation. Optionally, the chatbot can provide capability for a user to override the adaptive CAG/RAG and explicitly select one of RAG or CAG. This innovative solution provides a robust, secure, and efficient method for deploying single chatbot across diverse business requirements (e.g., multiple different business or customer/client/patient services, products, and/or cases, each with its own dedicated data sources and user bases). Further, an API gateway is provided to manage and route requests to the appropriate data sources, which can simplify the integration of new data sources and provide a centralized point for implementing security and monitoring features.

These and other aspects of the unified generative AI-based chatbot platform interfacing with a single data pool collecting data from across multiple data sources, the unified generative AI-based chatbot platform operating based on role-based access and/or adaptive CAG/RAG are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a unified generative AI-based chatbot platform, a first user query from a first user device associated with a first user, the first user query requesting first data obtained from one or more data sources; filtering, by the unified generative AI-based chatbot platform and using a first role-based access controlled chatbot among a plurality of role-based access controlled chatbots each mapped to one or more data sources among a plurality of data sources, access to data contained in a unified data store that contains a plurality of data retrieved from the plurality of data sources, based on a first user role associated with the first user, the first role-based access controlled chatbot being assigned to the first user based on the first user role and being restricted to accessing designated portions of the unified data store and to accessing data stored in a CAG store or a RAG store corresponding to the data stored in the designated portions of the unified data store; retrieving, by the unified generative AI-based chatbot platform and using the first role-based access controlled chatbot, first data through the filtered access to the data contained in the unified data store via at least one of the CAG store or the RAG store, the CAG store containing a summary of prior communication exchanges related to the first data accessible from the unified data store, the RAG store containing the first data retrieved from the unified data store; generating, by the unified generative AI-based chatbot platform, a query response to the first user query based on the first data retrieved through the filtered access to the data contained in the unified data store via the at least one of the CAG store or the RAG store; and presenting, by the unified generative AI-based chatbot platform, the query response on the first user device associated with the first user.

In another aspect, the technology relates to a system, including a processing system; and memory coupled to the processing system. The memory includes computer executable instructions that, when executed by the processing system, causes the system to perform operations including: receiving a first user query from a first user device associated with a first user, the first user query requesting first data obtained from one or more data sources; filtering, using a first role-based access controlled chatbot among a plurality of role-based access controlled chatbots each mapped to one or more data sources among a plurality of data sources, access to data contained in a unified data store that contains a plurality of data retrieved from the plurality of data sources, based on a first user role associated with the first user, the first role-based access controlled chatbot being assigned to the first user based on the first user role and being restricted to accessing designated portions of the unified data store and to accessing data stored in a CAG store or a RAG store corresponding to the data stored in the designated portions of the unified data store; retrieving, using the first role-based access controlled chatbot, first data through the filtered access to the data contained in the unified data store via at least one of the CAG store or the RAG store, the CAG store containing a summary of prior communication exchanges related to the first data accessible from the unified data store, the RAG store containing the first data retrieved from the unified data store; generating a query response to the first user query based on the first data retrieved through the filtered access to the data contained in the unified data store via the at least one of the CAG store or the RAG store; and presenting the query response on the first user device associated with the first user.

In yet another aspect, the technology relates to a method, including: receiving, by a unified generative AI-based chatbot platform, a first user query from a first user device associated with a first user, the first user query requesting first data obtained from one or more data sources; determining, by the unified generative AI-based chatbot platform, query type and requirements, by analyzing the first user query to determine whether the first user query is a first query type associated with at least one of queries related to frequently accessed data or queries related to recent interactions or a second query type associated with at least one of queries requiring real-time data retrieval or queries related to less common topics; verifying, by the unified generative AI-based chatbot platform, information associated with a CAG store to determine a cache hit rate of the CAG store corresponding to a confidence score indicating a probability that the CAG store contains the first data being requested; determining, by the unified generative AI-based chatbot platform, whether the first user query requires a quick response or comprehensive information retrieval; determining, by the unified generative AI-based chatbot platform, at least one of whether the first user query requires current information or whether cached information stored in the CAG store is sufficient and up-to-date; autonomously and adaptively selecting, by the unified generative AI-based chatbot platform, at least one of the CAG store or a RAG store based on selection criteria based on determinations regarding query type and requirements, the cache hit rate, one of the quick response or the comprehensive information retrieval, and the at least one of whether the first user query requires current information or whether cached information stored in the CAG store is sufficient and up-to-date; retrieving, by the unified generative AI-based chatbot platform and using a first role-based access controlled chatbot among a plurality of role-based access controlled chatbots each mapped to one or more data sources among a plurality of data sources, first data via the autonomously and adaptively selected at least one of the CAG store or the RAG store, the CAG store containing a summary of prior communication exchanges related to the first data corresponding to data accessible from a unified data store, the RAG store containing the first data corresponding to the data retrieved from the unified data store, the unified data store containing a plurality of data retrieved from the plurality of data sources; generating, by the unified generative AI-based chatbot platform, a query response to the first user query based on the first data retrieved via the at least one of the CAG store or the RAG store; and presenting, by the unified generative AI-based chatbot platform, the query response on the first user device associated with the first user.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

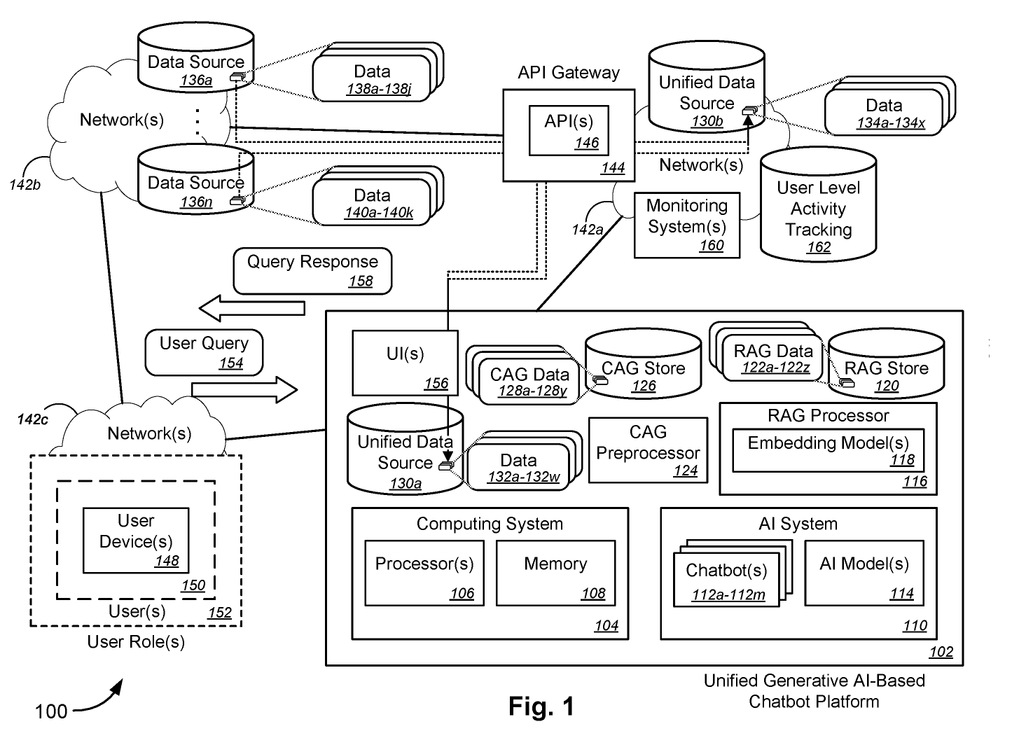

Turning to the embodiments as illustrated by the drawings, FIGS. 1-5 illustrate some of the features of methods, systems, and apparatuses for implementing a unified generative AI-based chatbot platform, and, more particularly, to methods, systems, and apparatuses for implementing a unified generative AI-based chatbot platform interfacing with a single data pool collecting data from across multiple data sources, the unified generative AI-based chatbot platform operating based on role-based access and/or adaptive CAG/RAG, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing a unified generative AI-based chatbot platform, in accordance with various embodiments.

In the non-limiting embodiment of FIG. 1, system 100 may include a unified generative AI-based chatbot platform 102. The unified generative AI-based chatbot platform 102 may include a computing system 104 including a processor(s) 106 and memory 108. The unified generative AI-based chatbot platform 102 may further include an AI system 110 including a plurality of chatbots 112a-112m and one or more AI models 114. In examples, the unified generative AI-based chatbot platform 102 may further include a RAG processor 116 based on one or more embedding models 118, and a RAG store 120 on which is stored RAG data 122a-122z. In some examples, the unified generative AI-based chatbot platform 102 may further include a CAG preprocessor 124 and a CAG store 126 on which is stored CAG data 128a-128y. In examples, the RAG data 122a-122z may contain vectorized versions of data that has been retrieved from data 132a-132w stored in unified data source 130a and/or vectorized versions of data that has been retrieved from data 134a-134x stored in unified data source 130b in network(s) 142a. In some examples, the CAG data 128a-128y may contain summaries of conversations between the user device(s) 148 and one or more chatbots 112 among the plurality of chatbots 112a-112m. In examples, the unified generative AI-based chatbot platform 102 or another device may retrieve data (e.g., from among data 138a-138j or data 140a-140k) from each of one or more data sources among a plurality of data sources 136a-136n in network(s) 142b, via application programming interface ("API") gateway 144 and/or API(s) 146 at network(s) 142a. Herein, j, k, m, w, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some examples, system 100 may further include one or more user devices 148 associated with corresponding one or more users 150 each having one or more user roles 152. In some cases, the one or more user devices 148 either may be disposed in network(s) 142c or may communicatively couple with unified generative AI-based chatbot platform 102 via network(s) 142c. In some instances, the user device(s) 148 may each include, but is not limited to, one of a desktop computer, a laptop computer, a tablet computer, a smart phone, a mobile phone, a network operations center ("NOC") computing system or console, or any suitable device capable of communicating with network(s) 115 or with servers or other network devices within network(s) 142a-142c, or via any suitable device over network(s) 115. In some cases, user(s) 150 may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some cases, user role(s) 152 may include, but is not limited to, one of an administrator, a technician, an agent, a customer, a company executive, a company manager, or an employee, and/or the like.

According to some embodiments, network(s) 142a-142c may each include, without limitation, one of a local area network ("LAN"), including, without limitation, a fiber network, an Ethernet network, a Token-Ring*** ERROR: No Symbol mapping for puaHex=00E4. Looks like ™ may have been intended. *** network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 142a-142c may include an access network of the service provider (e.g., an Internet service provider ("ISP")). In another embodiment, the network(s) 142a-142c may include a core network of the service provider and/or the Internet.

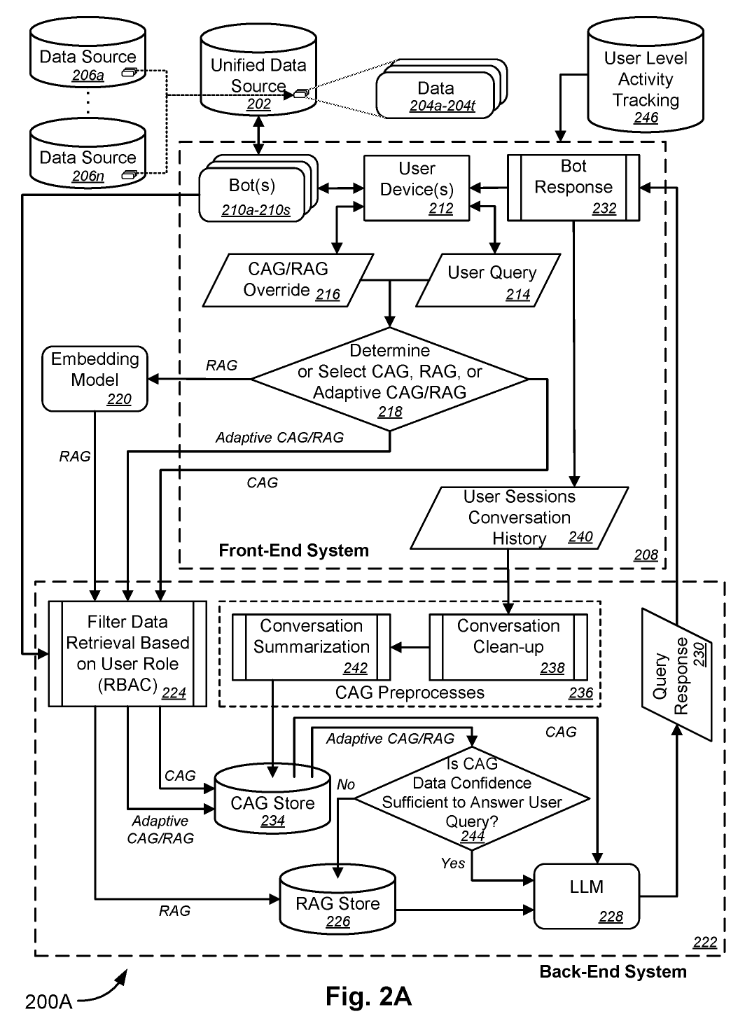

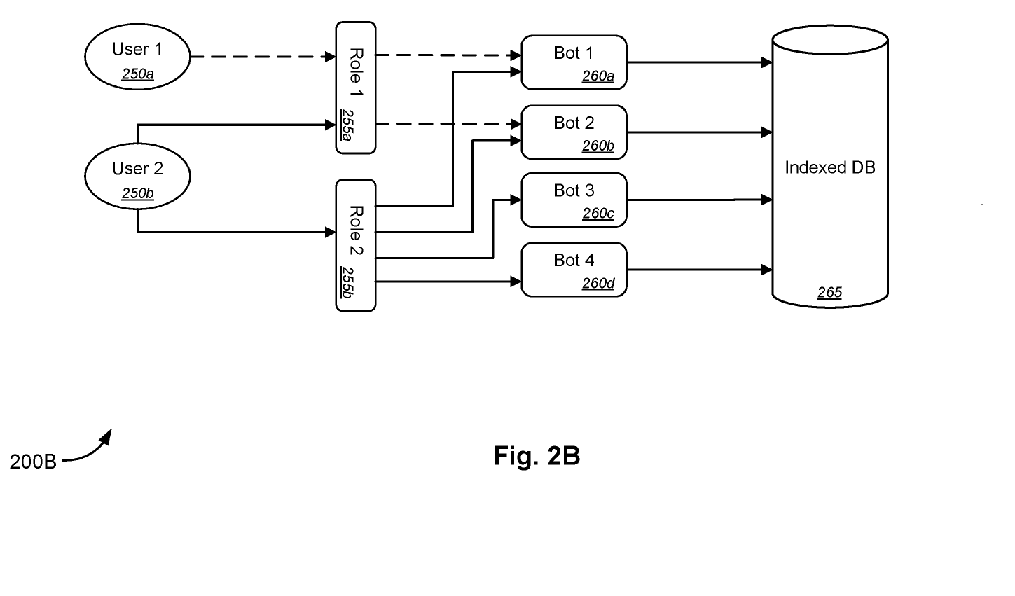

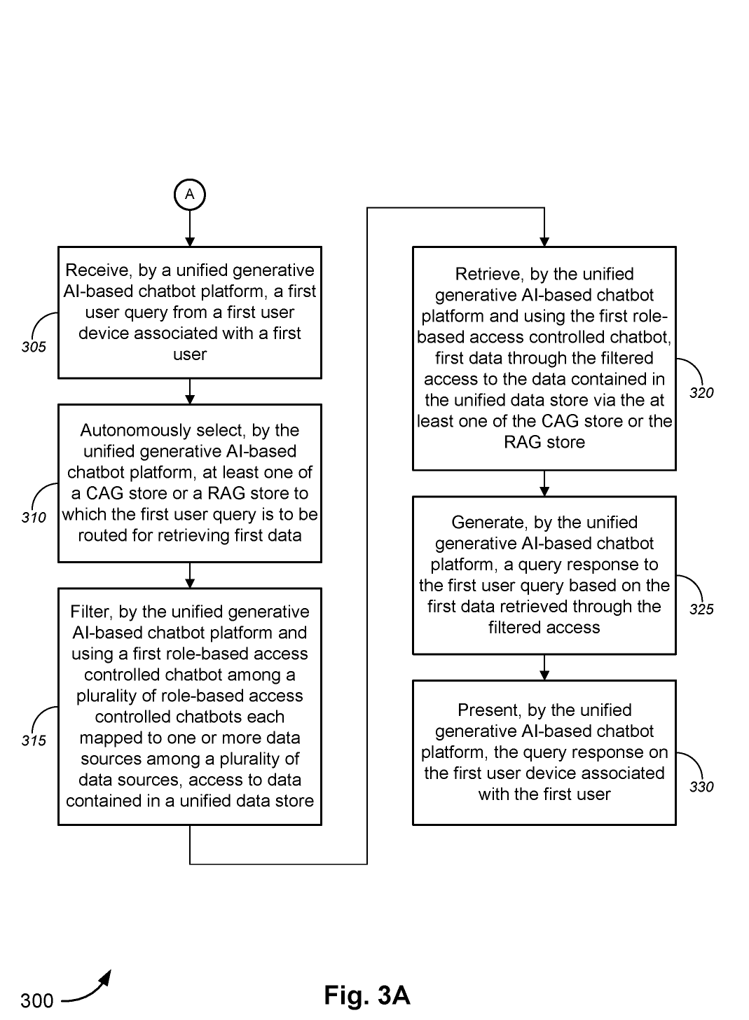

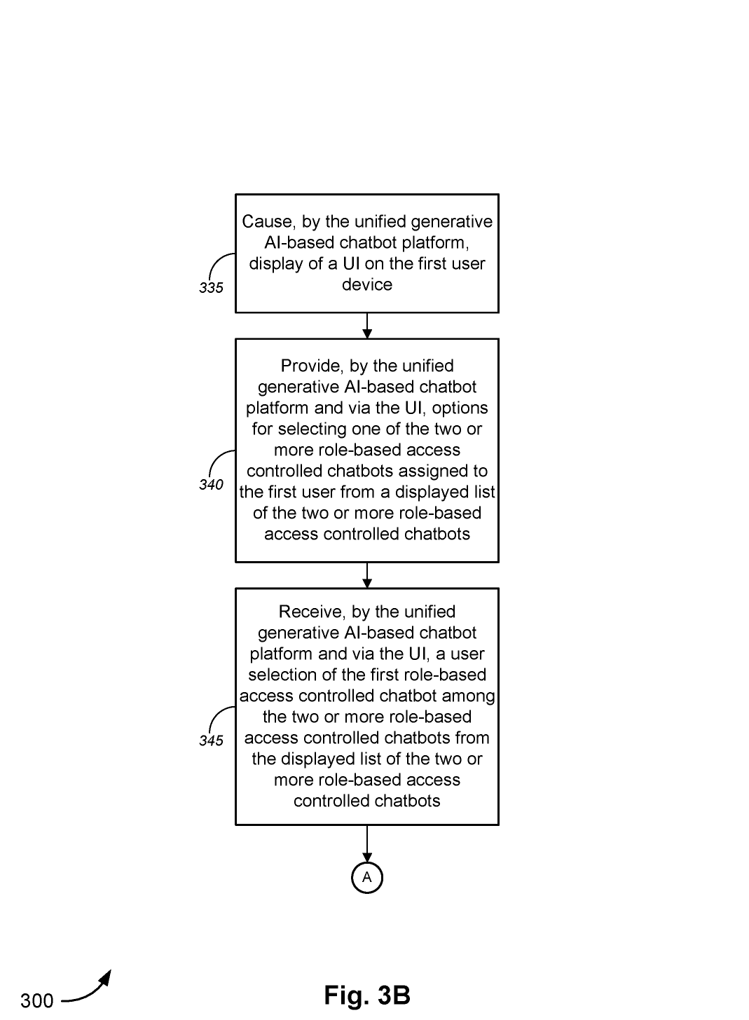

In some aspects, the user device(s) 148 may receive a user query 154 from a user(s) 150, and may send the user query 154 to unified generative AI-based chatbot platform 102. The unified generative AI-based chatbot platform 102 may utilize one or more chatbots 112 assigned to the user(s) 150 based on the user role(s) 152 of the user(s) 150. The computing system 104 (and the processor(s) 106) and/or the AI system 110 of the unified generative AI-based chatbot platform 102 may receive the user query 214 via user interface(s) ("UI(s)") 156, and may autonomously determine or select CAG, RAG, or adaptive CAG/RAG based on selection criteria as described in detail below with respect to FIGS. 2A, 3, and/or 4. The computing system 104 (and the processor(s) 106) and/or the AI system 110 of the unified generative AI-based chatbot platform 102 may generate a query response 158 based on CAG data (among CAG data 128a-128y) and/or RAG data (among RAG data 122a-122z) obtained from corresponding CAG store 126 and/or RAG store 120. The unified generative AI-based chatbot platform 102 may send the query response 158 to the user device(s) 148 via the UI(s) 156 and via network(s) 142c.

In some examples, a monitoring system 160 in network(s) 142a may track user level activity and may store the user level activity in user level activity tracking database(s) 162. In examples, the user level activity tracking data may be used as a basis for determining or selecting CAG, RAG, or adaptive CAG/RAG, for generating the query response 158, and/or for providing the query response 158 to the user device(s) 148.

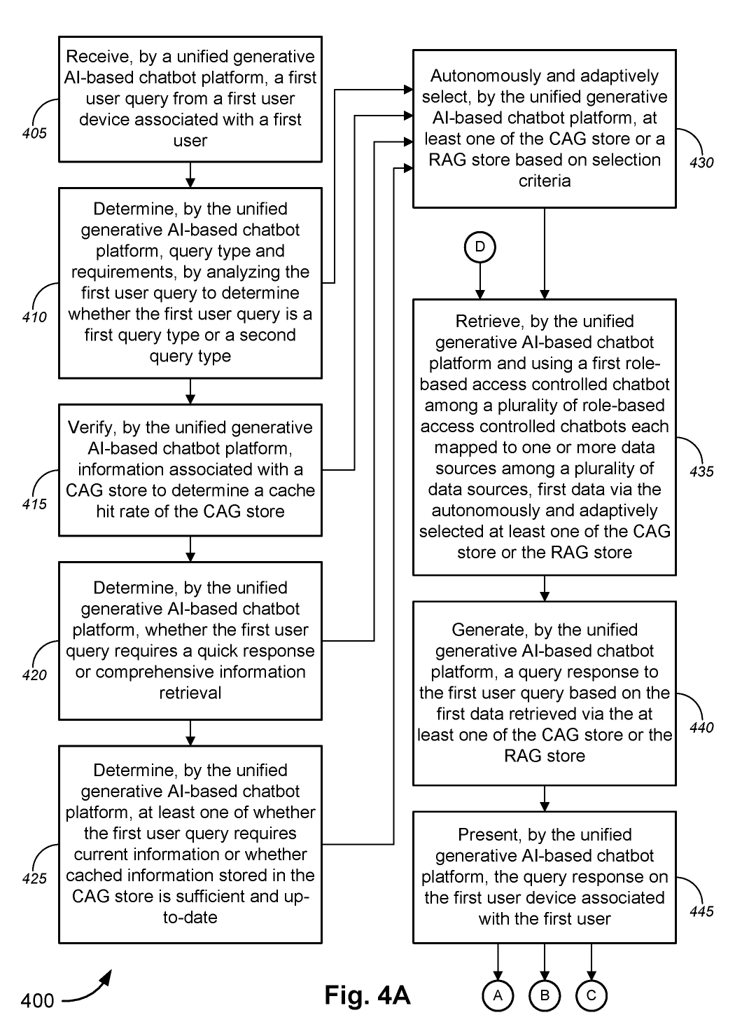

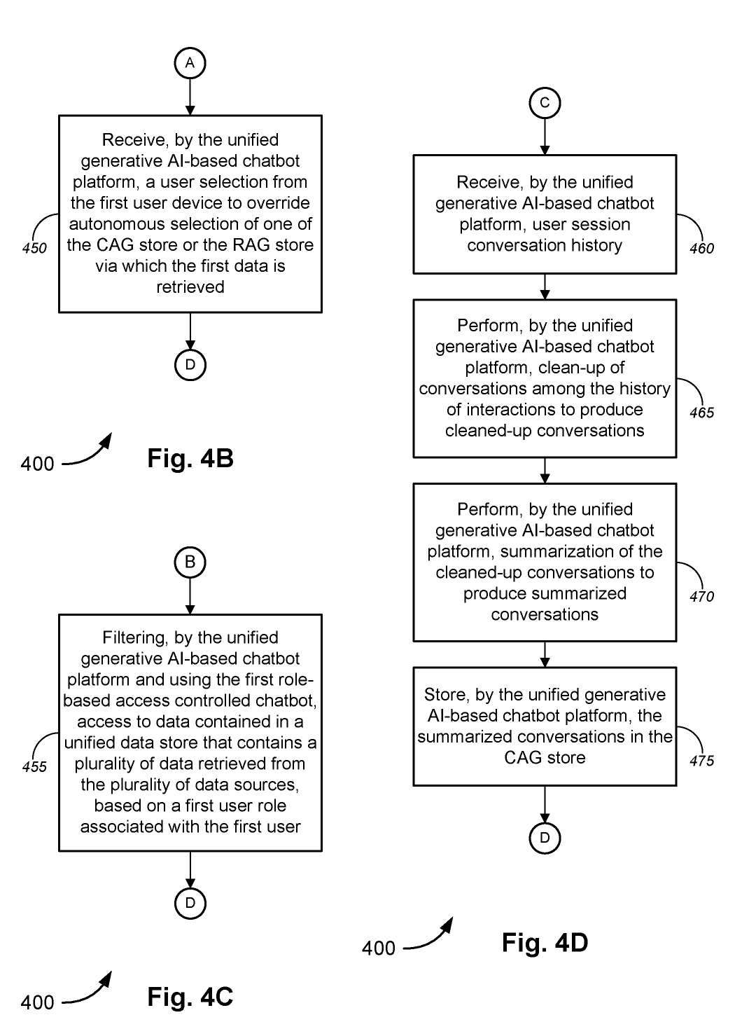

In operation, unified generative AI-based chatbot platform 102 and/or components thereof (including computing system 104 and/or AI system 110) may perform methods for implementing a unified generative AI-based chatbot platform, as described in detail with respect to FIGS. 2A-4D. For example, example sequence flow 200A and example role-based relationships 200B as described below with respect to FIGS. 2A and 2B, and methods 300 and 400 as described below with respect to FIGS. 3A-3B and 4A-4D may be applied with respect to the operations of system 100 of FIG. 1.

FIG. 2A depicts an example sequence flow 200A for implementing the unified generative AI-based chatbot platform, in accordance with various embodiments. FIG. 2B depicts example role-based relationships 200B between users and bots that are used for implementing the unified generative AI-based chatbot platform, in accordance with various embodiments. In some embodiments, unified data source 202 or indexed database 265, data 204a-204t, data sources 206a-206n, bot(s) 210a-210s and 260a-260d, user device(s) 212, user query 214, embedding model 220, RAG store 226, LLM 228, query response 230, CAG store 234, user level activity tracking database 246, users 250a and 250b, and roles 255a and 255b of FIGS. 2A and 2B may be similar, if not identical, to the unified data source 130a or 130b, data 132a-132w, 134a-134x, 138a-138j, and/or 140a-140k, data sources 136a-136n, chatbots 112a-112m, user device(s) 148, user query 154, embedding model(s) 118, RAG store 120, AI model(s) 114, query response 158, CAG store 126, user level activity tracking database 162, user(s) 150, and user role(s) 152, respectively, of system 100 of FIG. 1, and the description of these components of system 100 of FIG. 1 are similarly applicable to the corresponding components of FIGS. 2A and 2B.

With reference to FIG. 2A, example sequence flow 200A may include a unified data source 202 storing data 204a-204t that is retrieved from a plurality of data sources 206a-206n. At or within a front-end system or environment 208 of a unified generative AI-based chatbot platform (e.g., unified generative AI-based chatbot platform 102 of FIG. 1), a plurality of bots 210a-210s may be restricted to accessing designated portions of the unified data source 202. The plurality of bots 210a-210s may each be mapped to one or more data sources among the plurality of data sources 206a-206n. One or more bots among the plurality of bots 210a-210s may be assigned to a user associated with user device(s) 212, based on a role(s) of the user. The user device(s) 212 may receive a user query 214 from the user, and may relay the user query 214 to the front-end system 208. In the case that the user selects to override autonomous selection of one of CAG or RAG, the user device(s) 212 may receive the CAG/RAG override 216, and may relay the CAG/RAG override 216 to the front-end system 208. In such cases, the front-end system 208 or the unified generative AI-based chatbot platform may select CAG or RAG identified in the CAG/RAG override 216 (at operation 218). Alternatively, in the case that the user does not select to override autonomous selection of one of CAG or RAG, the front-end system 208 or the unified generative AI-based chatbot platform may autonomously determine or select one of CAG, RAG, or an adaptive CAG/RAG based on one or more selection criteria (at operation 218).

In examples, the one or more selection criteria may include at least one of: (a) selection based on query type; (b) selection based on cache hit rate of CAG; (c) selection based on response time; and/or (d) selection based on data freshness; and/or the like. For the selection based on query type, the query type may include a first query type associated with at least one of queries related to frequently accessed data or queries related to recent interactions and a second query type associated with at least one of queries requiring real-time data retrieval or queries related to less common topics. In such examples, with reference to operation 218, the front-end system 208 or the unified generative AI-based chatbot platform may autonomously determine or select query type and requirements, in some cases, by analyzing the user query 214 to determine whether the user query 214 is the first query type or the second query type. In particular, the front-end system 208 or the unified generative AI-based chatbot platform may autonomously determine or select CAG for queries of the first query type and may autonomously determine or select RAG for queries of the second query type. For the selection based on cache hit rate of CAG, the front-end system 208 or the unified generative AI-based chatbot platform may verify information associated with CAG to determine the cache hit rate of CAG. In particular, referring to operation 218, the front-end system 208 or the unified generative AI-based chatbot platform may autonomously determine or select CAG when the cache hit rate is at or exceeds a threshold cache hit rate value and may autonomously determine or select RAG when the cache hit rate is below the threshold cache hit rate value, where the threshold cache hit rate value (also referred to as a threshold confidence score) is of a value in a range between 60 and 80 percent. For the selection based on response time, with reference to operation 218, the front-end system 208 or the unified generative AI-based chatbot platform may autonomously determine or select CAG for queries requiring a quick response, and may autonomously determine or select RAG for queries requiring comprehensive data retrieval. For the selection based on data freshness, referring to the operation 218, the front-end system 208 or the unified generative AI-based chatbot platform may autonomously determine or select CAG when cached information is determined to be sufficient and up-to-date, and may autonomously determine or select RAG for queries requiring the latest information. After selection of CAG, RAG, or adaptive CAG/RAG at the front-end system 208, data filter, data retrieval, and query response generation may be performed at a back-end system 222 of the unified generative AI-based chatbot platform.

In the case that RAG is selected (from operation 218), textual data in the user query 214 may be vectorized using the embedding model 220. At operation 224, the back-end system 222 or the unified generative AI-based chatbot platform may use RBAC and/or may use a role-based access controlled bot 210 among a plurality of role-based access controlled bots 210a-210s to filter access to data contained in the unified data source 202, via RAG store 226. In examples, RBAC is used to differentiate from among the plurality of bots 210a-210s based on project identifier ("ID"), bot ID, etc. The back-end system 222 or the unified generative AI-based chatbot platform may use LLM 228 to generate a query response 230 based on RAG data stored in the RAG store 226 (e.g., based on the filtered access to the data contained in the unified data source 202 via the RAG store 226). At operation 232, the front-end system 208 or the unified generative AI-based chatbot platform may provide a bot response to the user device(s) 212 based on the query response 230 generated based on the RAG data by the LLM 228 at the back-end system 222.

In the case that the CAG is selected (from operation 218), the back-end system 222 or the unified generative AI-based chatbot platform may use RBAC and/or may use a role-based access controlled bot 210 among the plurality of role-based access controlled bots 210a-210s to filter access to data contained in the unified data source 202, via CAG store 234. In examples, RBAC is used to differentiate from among the plurality of bots 210a-210s based on project ID, bot ID, etc. In some examples, CAG preprocesses 236 may be performed prior to storing data in the CAG store. The CAG preprocesses 236 may include conversation clean-up (at operation 238) of user sessions conversation history 240 from prior bot responses 232, and conversation summarization (at operation 242). The back-end system 222 or the unified generative AI-based chatbot platform may use LLM 228 to generate another query response 230 based on CAG data (e.g., conversation summary data) stored in the CAG store 234 (e.g., based on the filtered access to the data contained in the unified data source 202 via the CAG store 234). At operation 232, the front-end system 208 or the unified generative AI-based chatbot platform may provide another bot response to the user device(s) 212 based on the query response 230 generated based on the CAG data by the LLM 228 at the back-end system 222.

In the case that the adaptive CAG/RAG is selected (from operation 218), the back-end system 222 or the unified generative AI-based chatbot platform may use RBAC and/or may use a role-based access controlled bot 210 among the plurality of role-based access controlled bots 210a-210s to filter access to data contained in the unified data source 202, via one or the other of the RAG store 226 or the CAG store 234. In examples, RBAC is used to differentiate from among the plurality of bots 210a-210s based on project ID, bot ID, etc. At operation 244, the back-end system 222 or the unified generative AI-based chatbot platform may determine whether a confidence score of the CAG data is sufficient to answer the user query 214. If so, the back-end system 222 or the unified generative AI-based chatbot platform may use LLM 228 to generate yet another query response 230 based on CAG data (e.g., conversation summary data) stored in the CAG store 234 (e.g., based on the filtered access to the data contained in the unified data source 202 via the CAG store 234). At operation 232, the front-end system 208 or the unified generative AI-based chatbot platform may provide yet another bot response to the user device(s) 212 based on the query response 230 generated based on the CAG data by the LLM 228 at the back-end system 222. If not, the back-end system 222 or the unified generative AI-based chatbot platform may use LLM 228 to generate still another query response 230 based on RAG data stored in the RAG store 226 (e.g., based on the filtered access to the data contained in the unified data source 202 via the RAG store 226). At operation 232, the front-end system 208 or the unified generative AI-based chatbot platform may provide still another bot response to the user device(s) 212 based on the query response 230 generated based on the RAG data by the LLM 228 at the back-end system 222.

In some examples, the unified generative AI-based chatbot platform may track user level activity and may store the user level activity in user level activity tracking database(s) 246. In examples, the user level activity tracking data may be used as a basis for determining or selecting CAG, RAG, or adaptive CAG/RAG, for generating the query response 230, and/or for providing bot response based on the query response 230.

Turning to FIG. 2B, example role-based relationships 200B may include a relationship between first user 250a and a first role 255a, and between the first role 255a and each of bots 260a and 260b. Example role-based relationships 200B of FIG. 2B may further include a relationship between second user 250b and both first role 255a and second role 255b, between the first role 255a and each of bots 260a and 260b, and between the second role 255b and each of bots 260a-260d. Each of bots 260a-260d (which may correspond to bot(s) 210a-210s and/or chatbots 112a-112m, or the like) may be restricted to accessing designated portions of the indexed database(s) 265 (which may correspond to unified data source 202). In examples, the role(s) of the user and/or the roles 255a and 255b may each include one of an administrator, a technician, an agent, a customer, a company executive, a company manager, or an employee, and/or the like. As shown in FIG. 2B, with the first role 255a, RBAC may provide access to the first and second bots 260a and 260b. Further as shown in FIG. 2B, with the second role 255b, RBAC may provide access to each of the first through fourth bots 260a-260d. For example, if the first role 255a is that of a technician, RBAC may provide access to a first bot 260a that may be restricted to a portion of the indexed database(s) 265 that contains data associated with service provided to a particular customer(s) whose service call is assigned to the technician, while also providing access to a second bot 260b that may be restricted to another portion of the indexed database(s) 265 that contains data associated with information proprietary to the service provider provisioning the service to customers. In another example, if the second role 255b is that of an administrator, RBAC may provide access to not only the first bot 260a and the second bot 260b, but also the third and fourth bots 260c and 260d, which may provide restricted access to corresponding other portions of the indexed database(s) 265. In examples, an administrator has the right to create roles and bots, and the right to assign them to users.

FIGS. 3A and 3B (collectively, "FIG. 3") depict flow diagrams illustrating an example method 300 for implementing a unified generative AI-based chatbot platform, in accordance with various embodiments. With reference to FIGS. 3A and 3B, the operations of example method 300 may be performed by a chatbot platform (e.g., unified generative AI-based chatbot platform 102 of FIG. 1) or components thereof, including a computing system (e.g., computing system 104 of FIG. 1), an AI system (e.g., AI system 110 of FIG. 1), a RAG processor (e.g., a RAG processor 116 of FIG. 1), and/or a CAG preprocessor (e.g., a CAG preprocessor 124 of FIG. 1). Method 300 continues from FIG. 3B onto FIG. 3A following the circular marker denoted, "A."

In the example method 300 of FIG. 3A, at operation 305, a unified generative AI-based chatbot platform may receive a user query (e.g., user query 154 of FIG. 1) from a user device (e.g., user device(s) 148 of FIG. 1) associated with a first user (e.g., user(s) 150 of FIG. 1). In some cases, the user query requests first data obtained from one or more data sources among a plurality of data sources (e.g., data sources 136a-136n of FIG. 1). At operation 310, the unified generative AI-based chatbot platform may autonomously select at least one of a CAG store (e.g., CAG store 126 of FIG. 1) or a RAG store (e.g., RAG store 120 of FIG. 1) to which the user query is to be routed for retrieving first data. At operation 315, the unified generative AI-based chatbot platform may filter, using a first role-based access controlled chatbot among a plurality of role-based access controlled chatbots (e.g., chatbots 112a-112m of FIG. 1) each mapped to the one or more data sources among the plurality of data sources, access to data contained in a unified data store (e.g., unified data source 130a or 130b of FIG. 1). In some instances, the unified data store may contain a plurality of data (e.g., data 132a-132w, 134a-134x, 138a-138j, and/or 140a-140k of FIG. 1) retrieved from the plurality of data sources, based on a first user role (e.g., user role(s) 152 of FIG. 1) associated with the first user. In some cases, the first role-based access controlled chatbot may be assigned to the first user based on the first user role, and may be restricted to accessing designated portions of the unified data store and to accessing data stored in the CAG store or the RAG store corresponding to the data stored in the designated portions of the unified data store. In examples, the first user role may include one of an administrator, a technician, an agent, a customer, a company executive, a company manager, or an employee, and/or the like. In some cases, at least one role-based access controlled chatbot, among the plurality of role-based access controlled chatbots, may each be mapped to two or more data sources among the plurality of data sources, each of the at least one role-based access controlled chatbot may be assigned to one user role among a plurality of user roles. In some examples, the unified generative AI-based chatbot platform may retrieve and store data from each of the one or more data sources, in some cases, via one of a corresponding API or an API gateway (e.g., API(s) 146 or API gateway 144 of FIG. 1).

At operation 320, the unified generative AI-based chatbot platform may retrieve, using the first role-based access controlled chatbot, first data through the filtered access to the data contained in the unified data store via the at least one of the CAG store or the RAG store. In examples, the CAG store may contain a summary of prior communication exchanges related to the first data accessible from the unified data store, while the RAG store may contain the first data retrieved from the unified data store. At operation 325, the unified generative AI-based chatbot platform may generate a query response (e.g., query response 158 of FIG. 1) to the user query, in some cases, based on the first data retrieved through the filtered access to the data contained in the unified data store via the at least one of the CAG store or the RAG store. At operation 330, the unified generative AI-based chatbot platform may present the query response on the user device associated with the first user.

In some examples, when the RAG store is selected for retrieving the first data (at operation 310), the unified generative AI-based chatbot platform may cause vectorization of textual data in the user query, using an embedding model (e.g., embedding model(s) 118 of FIG. 1), to produce a vectorized query that is used to query the RAG store. Alternatively, autonomously selecting the at least one of the CAG store or the RAG store (at operation 310) may include the unified generative AI-based chatbot platform autonomously and adaptively selecting at least one of the CAG store or the RAG store based on one or more selection criteria. In examples, the unified generative AI-based chatbot platform may receive a user selection from the user device to override autonomous selection of one of the CAG store or the RAG store via which the first data is retrieved, where the user selection may include user selection of one of the CAG store or the RAG store. In some cases, retrieving the first data through the filtered access to the data contained in the unified data store (at operation 320) may be performed via a user selected one of the CAG store or the RAG store. In some examples, when the unified generative AI-based chatbot platform has not received a user selection to override autonomous selection of the one of the CAG store or the RAG store, the unified generative AI-based chatbot platform may autonomously select at least one of the CAG store or the RAG store based on the one or more selection criteria.

In examples, the one or more selection criteria may include at least one of: (a) selection based on query type; (b) selection based on cache hit rate of the CAG store; (c) selection based on response time; and/or (d) selection based on data freshness; and/or the like. For the selection based on query type, the query type may include a first query type associated with at least one of queries related to frequently accessed data or queries related to recent interactions and a second query type associated with at least one of queries requiring real-time data retrieval or queries related to less common topics. In such examples, with reference to operation 310, the unified generative AI-based chatbot platform may determine query type and requirements, in some cases, by analyzing the user query to determine whether the user query is the first query type or the second query type. In particular, the unified generative AI-based chatbot platform may autonomously select the CAG store for queries of the first query type and may autonomously select the RAG store for queries of the second query type. For the selection based on cache hit rate of the CAG store, referring to operation 310, the unified generative AI-based chatbot platform may verify information associated with the CAG store to determine the cache hit rate of the CAG store. In particular, the unified generative AI-based chatbot platform may autonomously select the CAG store when the cache hit rate is at or exceeds a threshold cache hit rate value and may autonomously select the RAG store when the cache hit rate is below the threshold cache hit rate value, where the threshold cache hit rate value (also referred to as a threshold confidence score) is of a value in a range between 60 and 80 percent. For the selection based on response time, with reference to operation 310, the unified generative AI-based chatbot platform may autonomously select the CAG store for queries requiring a quick response, and may autonomously select the RAG store for queries requiring comprehensive data retrieval. For the selection based on data freshness, referring to the operation 310, the unified generative AI-based chatbot platform may autonomously select the CAG store when cached information is determined to be sufficient and up-to-date, and may autonomously select the RAG store for queries requiring the latest information.

In some examples, for the CAG store, the unified generative AI-based chatbot platform may perform CAG preprocessing (e.g., using CAG preprocessor 124 of FIG. 1). In examples, the CAG preprocessing may include the unified generative AI-based chatbot platform (1) receiving user session conversation history including a history of interactions between the first user and the first role-based access controlled chatbot of the unified generative AI-based chatbot platform; (2) performing clean-up of conversations among the history of interactions to produce cleaned-up conversations; (3) performing summarization of the cleaned-up conversations to produce summarized conversations; and (4) storing the summarized conversations in the CAG store. In some instances, performing the clean-up of conversations may include one of removing or masking at least one of personally identifiable information, identifiers associated with specific resources or services, links to specific resources, forms associated with services, non-relevant information, information associated to specific service tickets associated with the services, or information that are determined to hinder summarization processes, and/or the like.

Referring to FIG. 3B, in some examples, two or more role-based access controlled chatbots, among the plurality of role-based access controlled chatbots, may be assigned to the first user based on the first user role. In some cases, the two or more role-based access controlled chatbots may include the first role-based access controlled chatbot. Prior to filtering the access to the data, method 300 may include the unified generative AI-based chatbot platform (i) causing display of a UI (e.g., user interface(s) 156 of FIG. 1) on the user device (at operation 335); (ii) providing, via the UI, options for selecting one of the two or more role-based access controlled chatbots assigned to the first user from a displayed list of the two or more role-based access controlled chatbots (at operation 340); and (iii) receiving, via the UI, a user selection of the first role-based access controlled chatbot among the two or more role-based access controlled chatbots from the displayed list of the two or more role-based access controlled chatbots (at operation 345). In some examples, the options for selecting one of the two or more role-based access controlled chatbots include a drop-down list within the UI that allows the user to select one of the role-based access controlled chatbots that are assigned to the first user, while hiding role-based access controlled chatbots that are not assigned to the first user. The selected chatbot acts as a single interface and can work as a different platform by context switching (e.g., by enabling switching between user profiles, user roles, and/or chatbots assigned to particular user roles restricting database access based on user roles, or the like). Method 300 may continue onto the process at operation 305 in FIG. 3A following the circular marker denoted, "A."

FIGS. 4A-4D (collectively, "FIG. 4") depict flow diagrams illustrating another example method 400 for implementing a unified generative AI-based chatbot platform, in accordance with various embodiments. Referring to FIGS. 4A-4D, the operations of example method 400 may be performed by a chatbot platform (e.g., unified generative AI-based chatbot platform 102 of FIG. 1) or components thereof, including a computing system (e.g., computing system 104 of FIG. 1), an AI system (e.g., AI system 110 of FIG. 1), a RAG processor (e.g., a RAG processor 116 of FIG. 1), and/or a CAG preprocessor (e.g., a CAG preprocessor 124 of FIG. 1). Method 400 continues from FIG. 4A onto one or more of FIGS. 4B-4D following the corresponding circular markers denoted, "A," "B," or "C," and returns to FIG. 4A following the circular marker denoted, "D."

In the example method 400 of FIG. 4A, at operation 405, a unified generative AI-based chatbot platform may receive a first user query (e.g., user query 154 of FIG. 1) from a first user device (e.g., user device(s) 148 of FIG. 1) associated with a first user (e.g., user(s) 150 of FIG. 1). In some cases, the first user query may request first data obtained from one or more data sources (e.g., data sources 136a-136n of FIG. 1). At operation 410, the unified generative AI-based chatbot platform may determine query type and requirements, in some cases, by analyzing the first user query to determine whether the first user query is a first query type associated with at least one of queries related to frequently accessed data or queries related to recent interactions or a second query type associated with at least one of queries requiring real-time data retrieval or queries related to less common topics. Alternatively or additionally, at operation 415, the unified generative AI-based chatbot platform may verify information associated with a CAG store (e.g., CAG store 126 of FIG. 1) to determine a cache hit rate of the CAG store, the cache hit rate corresponding to a confidence score indicating a probability that the CAG store contains the first data being requested. Alternatively or additionally, at operation 420, the unified generative AI-based chatbot platform may determine whether the first user query requires a quick response or comprehensive information retrieval. Alternatively or additionally, at operation 425, the unified generative AI-based chatbot platform may determine at least one of whether the first user query requires current information or whether cached information stored in the CAG store is sufficient and up-to-date.

At operation 430, the unified generative AI-based chatbot platform may autonomously and adaptively select at least one of the CAG store or a RAG store (e.g., RAG store 120 of FIG. 1), based on selection criteria, in some cases, based on determinations regarding query type and requirements (from operation 410), the cache hit rate (from operation 415), one of the quick response or the comprehensive information retrieval (from operation 420), and/or the at least one of whether the first user query requires current information or whether cached information stored in the CAG store is sufficient and up-to-date (from operation 425). In particular, autonomously and adaptively selecting at least one of the CAG store or the RAG store (at operation 430) may be based on a combination of factors including: (a) selection based on query type, in which the CAG store may be autonomously selectable for queries of the first query type and the RAG store may be autonomously selectable for queries of the second query type; (b) selection based on cache hit rate of the CAG store, in which the CAG store may be autonomously selectable when the cache hit rate is at or exceeds a threshold cache hit rate value and the RAG store may be autonomously selectable when the cache hit rate is below the threshold cache hit rate value; (c) selection based on response time, in which the CAG store may be autonomously selectable for queries requiring a quick response and the RAG store may be autonomously selectable for queries requiring comprehensive data retrieval; or (d) selection based on data freshness, in which the CAG store may be autonomously selectable when cached information is determined to be sufficient and up-to-date and the RAG store may be autonomously selectable for queries requiring the latest information.

At operation 435, the unified generative AI-based chatbot platform may retrieve, using a first role-based access controlled chatbot among a plurality of role-based access controlled chatbots (e.g., chatbots 112a-112m of FIG. 1) each mapped to one or more data sources among a plurality of data sources, first data via the autonomously and adaptively selected at least one of the CAG store or the RAG store. In examples, the CAG store may contain a summary of prior communication exchanges related to the first data corresponding to data accessible from a unified data store (e.g., unified data source 130a or 130b of FIG. 1), while the RAG store may contain the first data corresponding to the data retrieved from the unified data store, and the unified data store may contain a plurality of data (e.g., data 132a-132w, 134a-134x, 138a-138j, and/or 140a-140k of FIG. 1) retrieved from the plurality of data sources. At operation 440, the unified generative AI-based chatbot platform may generate a query response (e.g., query response 158 of FIG. 1) to the first user query based on the first data retrieved via the at least one of the CAG store or the RAG store. At operation 445, the unified generative AI-based chatbot platform may present the query response on the first user device associated with the first user.

Method 400 may continue onto one or more of the process at operation 450 following the circular marker denoted, "A," the process at operation 455 following the circular marker denoted, "B," and/or the process at operation 460 following the circular marker denoted, "C."

At operation 450 in FIG. 4B (following the circular marker denoted, "A," in FIG. 4A), method 400 may include the unified generative AI-based chatbot platform receiving a user selection from the first user device to override autonomous selection of one of the CAG store or the RAG store via which the first data is retrieved. In some examples, the user selection may include user selection of one of the CAG store or the RAG store. In such examples, retrieving the first data (at operation 435) may be performed via a user selected one of the CAG store or the RAG store (from operation 450). Method 400 may return to the process at operation 435 following the circular marker denoted, "D."

At operation 455 in FIG. 4B (following the circular marker denoted, "B," in FIG. 4A), method 400 may include the unified generative AI-based chatbot platform filtering access to data contained in a unified data store that contains a plurality of data retrieved from the plurality of data sources, using the first role-based access controlled chatbot and based on a first user role (e.g., user role(s) 152 of FIG. 1) associated with the first user. In some examples, the first role-based access controlled chatbot may be assigned to the first user based on the first user role, and may be restricted to accessing designated portions of the unified data store and to accessing data stored in the CAG store or the RAG store corresponding to the data stored in the designated portions of the unified data store. In some cases, the first data may be retrieved through the filtered access to the data contained in the unified data store via at least one of the CAG store or the RAG store. Method 400 may return to the process at operation 435 following the circular marker denoted, "D."

At operation 460 in FIG. 4B (following the circular marker denoted, "C," in FIG. 4A), method 400 may include the unified generative AI-based chatbot platform receiving user session conversation history. In some examples, the user session conversation history may include a history of interactions between the first user and the first role-based access controlled chatbot of the unified generative AI-based chatbot platform. At operation 465, the unified generative AI-based chatbot platform may perform clean-up of conversations among the history of interactions to produce cleaned-up conversations. In examples, perform clean-up of conversations may include performing one of removing or masking at least one of personally identifiable information, identifiers associated with specific resources or services, links to specific resources, forms associated with services, non-relevant information, information associated to specific service tickets associated with the services, or information that are determined to hinder summarization processes, and/or the like. At operation 470, the unified generative AI-based chatbot platform may perform summarization of the cleaned-up conversations to produce summarized conversations. At operation 475, the unified generative AI-based chatbot platform may store the summarized conversations in the CAG store. Method 400 may return to the process at operation 435 following the circular marker denoted, "D."

While the techniques and procedures in methods 300 and 400 are depicted and/or described in a certain order for purposes of illustration, it should be appreciated that certain procedures may be reordered and/or omitted within the scope of various embodiments. Moreover, while the methods 300 and 400 may be implemented by or with (and, in some cases, are described below with respect to) the systems, examples, or embodiments 100, 200A, and 200B of FIGS. 1, 2A, and 2B, respectively (or components thereof), such methods may also be implemented using any suitable hardware (or software) implementation. Similarly, while each of the systems, examples, or embodiments 100, 200A, and 200B of FIGS. 1, 2A, and 2B, respectively (or components thereof), can operate according to the methods 300 and 400 (e.g., by executing instructions embodied on a computer readable medium), the systems, examples, or embodiments 200A, and 200B of FIGS. 1, 2A, and 2B can each also operate according to other modes of operation and/or perform other suitable procedures.

### Exemplary System and Hardware Implementation

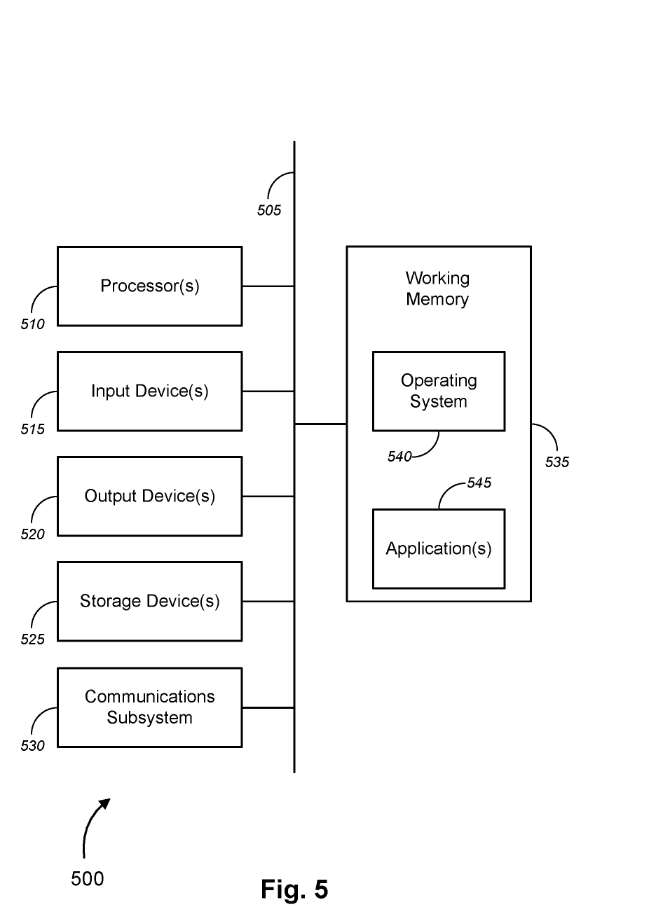

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., unified generative AI-based chatbot platform 102, computing system 104, AI system 110, RAG processor 116, CAG preprocessor 124, API gateway 144, user device(s) 148 or 212, and monitoring system(s) 160, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500 – which might represent an embodiment of the computer or hardware system (i.e., unified generative AI-based chatbot platform 102, computing system 104, AI system 110, RAG processor 116, CAG preprocessor 124, API gateway 144, user device(s) 148 or 212, and monitoring system(s) 160, etc.), described above with respect to FIGS. 1-4 – is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network ("WWAN") device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a unified generative artificial intelligence ("AI") -based chatbot platform, a first user query from a first user device associated with a first user, the first user query requesting first data obtained from one or more data sources;
filtering, by the unified generative AI-based chatbot platform and using a first role-based access controlled chatbot among a plurality of role-based access controlled chatbots each mapped to one or more data sources among a plurality of data sources, access to data contained in a unified data store that contains a plurality of data retrieved from the plurality of data sources, based on a first user role associated with the first user, the first role-based access controlled chatbot being assigned to the first user based on the first user role and being restricted to accessing designated portions of the unified data store and to accessing data stored in a cache augmented generation ("CAG") store or a retrieval augmented generation ("RAG") store corresponding to the data stored in the designated portions of the unified data store;
retrieving, by the unified generative AI-based chatbot platform and using the first role-based access controlled chatbot, first data through the filtered access to the data contained in the unified data store via at least one of the CAG store or the RAG store, the CAG store containing a summary of prior communication exchanges related to the first data accessible from the unified data store, the RAG store containing the first data retrieved from the unified data store;
generating, by the unified generative AI-based chatbot platform, a query response to the first user query based on the first data retrieved through the filtered access to the data contained in the unified data store via the at least one of the CAG store or the RAG store; and
presenting, by the unified generative AI-based chatbot platform, the query response on the first user device associated with the first user.

2. The method of claim 1, further comprising:
autonomously selecting, by the unified generative AI-based chatbot platform, at least one of the CAG store or the RAG store to which the first user query is routed for retrieving the first data.

3. The method of claim 2, further comprising:
when the RAG store is selected for retrieving the first data, causing, by the unified generative AI-based chatbot platform and using an embedding model, vectorization of textual data in the first user query to produce a vectorized query that is used to query the RAG store.

4. The method of claim 2, wherein autonomously selecting the at least one of the CAG store or the RAG store comprises autonomously and adaptively selecting, by the unified generative AI-based chatbot platform, at least one of the CAG store or the RAG store based on one or more selection criteria.

5. The method of claim 4, further comprising:
receiving, by the unified generative AI-based chatbot platform, a user selection from the first user device to override autonomous selection of one of the CAG store or the RAG store via which the first data is retrieved, the user selection including user selection of one of the CAG store or the RAG store, wherein retrieving the first data through the filtered access to the data contained in the unified data store is performed via a user selected one of the CAG store or the RAG store; and
when the unified generative AI-based chatbot platform has not received a user selection to override autonomous selection of the one of the CAG store or the RAG store, autonomously selecting, by the unified generative AI-based chatbot platform, at least one of the CAG store or the RAG store based on the one or more selection criteria.

6. The method of claim 4, wherein the one or more selection criteria include at least one of:
selection based on query type, wherein the query type includes a first query type associated with at least one of queries related to frequently accessed data or queries related to recent interactions and a second query type associated with at least one of queries requiring real-time data retrieval or queries related to less common topics, wherein the unified generative AI-based chatbot platform autonomously selects the CAG store for queries of the first query type and autonomously selects the RAG store for queries of the second query type;
selection based on cache hit rate of the CAG store, wherein the unified generative AI-based chatbot platform autonomously selects the CAG store when the cache hit rate is at or exceeds a threshold cache hit rate value and autonomously selects the RAG store when the cache hit rate is below the threshold cache hit rate value;
selection based on response time, wherein the unified generative AI-based chatbot platform autonomously selects the CAG store for queries requiring a quick response and autonomously selects the RAG store for queries requiring comprehensive data retrieval; or
selection based on data freshness, wherein the unified generative AI-based chatbot platform autonomously selects the CAG store when cached information is determined to be sufficient and up-to-date and autonomously selects the RAG store for queries requiring the latest information.

7. The method of claim 6, further comprising:
determining, by the unified generative AI-based chatbot platform, query type and requirements, by analyzing the first user query to determine whether the first user query is the first query type or the second query type.

8. The method of claim 6, further comprising:
verifying, by the unified generative AI-based chatbot platform, information associated with the CAG store to determine the cache hit rate of the CAG store.

9. The method of claim 1, further comprising:
retrieving and storing, by the unified generative AI-based chatbot platform, data from each of the one or more data sources, via one of a corresponding application programming interface ("API") or an API gateway.

10. The method of claim 1, further comprising:
receiving, by the unified generative AI-based chatbot platform, user session conversation history including a history of interactions between the first user and the first role-based access controlled chatbot of the unified generative AI-based chatbot platform;
performing, by the unified generative AI-based chatbot platform, clean-up of conversations among the history of interactions to produce cleaned-up conversations, by performing one of removing or masking at least one of personally identifiable information, identifiers associated with specific resources or services, links to specific resources, forms associated with services, non-relevant information, information associated to specific service tickets associated with the services, or information that are determined to hinder summarization processes;
performing, by the unified generative AI-based chatbot platform, summarization of the cleaned-up conversations to produce summarized conversations; and
storing, by the unified generative AI-based chatbot platform, the summarized conversations in the CAG store.

11. The method of claim 1, wherein the first user role is one of an administrator, a technician, an agent, a customer, a company executive, a company manager, or an employee.

12. The method of claim 1, wherein at least one role-based access controlled chatbot, among the plurality of role-based access controlled chatbots, is each mapped to two or more data sources among the plurality of data sources, each of the at least one role-based access controlled chatbot is assigned to one user role among a plurality of user roles.

13. The method of claim 1, wherein two or more role-based access controlled chatbots, among the plurality of role-based access controlled chatbots, are assigned to the first user based on the first user role, the two or more role-based access controlled chatbots including the first role-based access controlled chatbot, wherein the method further comprises, prior to filtering the access to the data:
causing, by the unified generative AI-based chatbot platform, display of a user interface ("UI") on the first user device;
providing, by the unified generative AI-based chatbot platform and via the UI, options for selecting one of the two or more role-based access controlled chatbots assigned to the first user from a displayed list of the two or more role-based access controlled chatbots; and
receiving, by the unified generative AI-based chatbot platform and via the UI, a user selection of the first role-based access controlled chatbot among the two or more role-based access controlled chatbots from the displayed list of the two or more role-based access controlled chatbots.

14. A system, comprising:
a processing system; and
memory coupled to the processing system, the memory comprising computer executable instructions that, when executed by the processing system, causes the system to perform operations comprising:
receiving a first user query from a first user device associated with a first user, the first user query requesting first data obtained from one or more data sources;
filtering, using a first role-based access controlled chatbot among a plurality of role-based access controlled chatbots each mapped to one or more data sources among a plurality of data sources, access to data contained in a unified data store that contains a plurality of data retrieved from the plurality of data sources, based on a first user role associated with the first user, the first role-based access controlled chatbot being assigned to the first user based on the first user role and being restricted to accessing designated portions of the unified data store and to accessing data stored in a cache augmented generation ("CAG") store or a retrieval augmented generation ("RAG") store corresponding to the data stored in the designated portions of the unified data store;
retrieving, using the first role-based access controlled chatbot, first data through the filtered access to the data contained in the unified data store via at least one of the CAG store or the RAG store, the CAG store containing a summary of prior communication exchanges related to the first data accessible from the unified data store, the RAG store containing the first data retrieved from the unified data store;
generating a query response to the first user query based on the first data retrieved through the filtered access to the data contained in the unified data store via the at least one of the CAG store or the RAG store; and
presenting the query response on the first user device associated with the first user.

15. The system of claim 14, wherein the system includes a unified generative artificial intelligence ("AI") -based chatbot platform.

16. A method, comprising:
receiving, by a unified generative artificial intelligence ("AI") -based chatbot platform, a first user query from a first user device associated with a first user, the first user query requesting first data obtained from one or more data sources;
determining, by the unified generative AI-based chatbot platform, query type and requirements, by analyzing the first user query to determine whether the first user query is a first query type associated with at least one of queries related to frequently accessed data or queries related to recent interactions or a second query type associated with at least one of queries requiring real-time data retrieval or queries related to less common topics;
verifying, by the unified generative AI-based chatbot platform, information associated with a cache augmented generation ("CAG") store to determine a cache hit rate of the CAG store corresponding to a confidence score indicating a probability that the CAG store contains the first data being requested;
determining, by the unified generative AI-based chatbot platform, whether the first user query requires a quick response or comprehensive information retrieval;
determining, by the unified generative AI-based chatbot platform, at least one of whether the first user query requires current information or whether cached information stored in the CAG store is sufficient and up-to-date;
autonomously and adaptively selecting, by the unified generative AI-based chatbot platform, at least one of the CAG store or a retrieval augmented generation ("RAG") store based on selection criteria based on determinations regarding query type and requirements, the cache hit rate, one of the quick response or the comprehensive information retrieval, and the at least one of whether the first user query requires current information or whether cached information stored in the CAG store is sufficient and up-to-date;
retrieving, by the unified generative AI-based chatbot platform and using a first role-based access controlled chatbot among a plurality of role-based access controlled chatbots each mapped to one or more data sources among a plurality of data sources, first data via the autonomously and adaptively selected at least one of the CAG store or the RAG store, the CAG store containing a summary of prior communication exchanges related to the first data corresponding to data accessible from a unified data store, the RAG store containing the first data corresponding to the data retrieved from the unified data store, the unified data store containing a plurality of data retrieved from the plurality of data sources;
generating, by the unified generative AI-based chatbot platform, a query response to the first user query based on the first data retrieved via the at least one of the CAG store or the RAG store; and
presenting, by the unified generative AI-based chatbot platform, the query response on the first user device associated with the first user.

17. The method of claim 16, further comprising:
receiving, by the unified generative AI-based chatbot platform, a user selection from the first user device to override autonomous selection of one of the CAG store or the RAG store via which the first data is retrieved, the user selection including user selection of one of the CAG store or the RAG store, wherein retrieving the first data is performed via a user selected one of the CAG store or the RAG store.

18. The method of claim 16, wherein autonomously and adaptively selecting at least one of the CAG store or the RAG store is based on a combination of factors including:
selection based on query type, in which the CAG store is autonomously selectable for queries of the first query type and the RAG store is autonomously selectable for queries of the second query type;
selection based on cache hit rate of the CAG store, in which the CAG store is autonomously selectable when the cache hit rate is at or exceeds a threshold cache hit rate value and the RAG store is autonomously selectable when the cache hit rate is below the threshold cache hit rate value;
selection based on response time, in which the CAG store is autonomously selectable for queries requiring a quick response and the RAG store is autonomously selectable for queries requiring comprehensive data retrieval; or
selection based on data freshness, in which the CAG store is autonomously selectable when cached information is determined to be sufficient and up-to-date and the RAG store is autonomously selectable for queries requiring the latest information.

19. The method of claim 16, further comprising:
filtering, by the unified generative AI-based chatbot platform and using the first role-based access controlled chatbot, access to data contained in a unified data store that contains a plurality of data retrieved from the plurality of data sources, based on a first user role associated with the first user, the first role-based access controlled chatbot being assigned to the first user based on the first user role and being restricted to accessing designated portions of the unified data store and to accessing data stored in the CAG store or the RAG store corresponding to the data stored in the designated portions of the unified data store;
wherein the first data is retrieved through the filtered access to the data contained in the unified data store via at least one of the CAG store or the RAG store.

20. The method of claim 16, further comprising:
receiving, by the unified generative AI-based chatbot platform, user session conversation history including a history of interactions between the first user and the first role-based access controlled chatbot of the unified generative AI-based chatbot platform;
performing, by the unified generative AI-based chatbot platform, clean-up of conversations among the history of interactions to produce cleaned-up conversations, by performing one of removing or masking at least one of personally identifiable information, identifiers associated with specific resources or services, links to specific resources, forms associated with services, non-relevant information, information associated to specific service tickets associated with the services, or information that are determined to hinder summarization processes;
performing, by the unified generative AI-based chatbot platform, summarization of the cleaned-up conversations to produce summarized conversations; and
storing, by the unified generative AI-based chatbot platform, the summarized conversations in the CAG store.
